(19) United States
(12) Patent Application Publication
(10) Pub. No.: US 2009/0048867 A1
(43) Pub. Date: Feb. 19, 2009

(54) DIAGNOSTIC RECORD INFORMATION MANAGEMENT SYSTEM AND DIAGNOSTIC RECORD INFORMATION MANAGEMENT METHOD

(76) Inventors: Shusuke Soejima, Tokyo (JP); Mamoru Umeki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/094,439

(22) PCT Filed: Nov. 14, 2006
(86) PCT No.: PCT/JP2006/322624

§ 371 Date: May 21, 2008

(30) Foreign Application Priority Data
Nov. 24, 2005 (JP) 2005-338389

(51) Int. Cl. G06Q 50/00

(52) U.S. Cl. 705/2

(57) ABSTRACT

The medical chart management system reads the paper medical charts made in the medical facilities with scanners installed in the medical facilities, converts them into image data and stores them in a paper medical chart information DB of a management server corresponding to the medical facilities. To search for image data including a certain medical term from the paper medical chart information DB, the management server obtains patterns for search which is a representation used in recording a medical term in a medical chart to be retrieved and which is inputted by hand with a pen tablet from the each medical facility and performs matching between the patters for search obtained and the image data on the paper charts stored in the paper medical chart information DB corresponding to the medical facilities at which the patterns for search are inputted.

### TECHNICAL FIELD

The present invention relates to a diagnostic record information management system and to a diagnostic record information management method for sharing diagnostic record information recorded on paper medical charts in plural medical facilities.

### BACKGROUND

With the recent development of communication network technologies, it has become possible for intraregional medical institutions (medical facilities) to join hands with others for ties by utilizing communication networks as is shown in Patent Document 1, for example, in medical fields.

As one of these ties of intraregional medical institutions, sharing of diagnostic records information, namely, sharing of the so-called medical chart information is studied. Even for this medical chart, computerization has started advancing, and electronic medical charts have made their appearance, thus, Patent Document 2 and Patent Document 3 disclose the technology, for example, to share diagnostic record information by using electronic medical chart information filed electronically.

Patent Document 1: Japanese Patent Application Publication No. 2003-308369

Patent Document 2: Japanese Patent Application Publication No. 11-219403

Patent Document 3: Japanese Patent Application Publication No. 2001-155100

### DISCLOSURE OF THE INVENTION

### Problems to be Solved by the Invention

However, Japanese language, German language and English language coexist in a medical term, and expressions which are used only in an individual department or in an individual facility are in existence, and a medical practitioner's office or a clinic having only one medical doctor has this tendency, in particular. Therefore, sharing and effective application of the diagnostic information in plural medical institutions are difficult under the condition only that contents of medical charts are filed electronically to be data.

In a core hospital having therein an in-house network, diagnoses are conducted with RIS (Radiology Information System) or HIS (Hospital Information System) as a center system, and by using PACS (Picture Archiving and Communication System for medical application) and electronic medical charts system. However, in a small-sized facility such as a practitioner's office and a clinic, there has been a basic problem that sharing of diagnostic record information is difficult, because the adoption rate of electronic medical charts is only a few percent, and paper medical charts are used overwhelmingly for records of diagnoses results. Though it is considered that contents of the description on paper charts are inputted by a key board to be digitized, this has been an unfeasible idea, because the idea requires the enormous amount of time and expense.

A problem of the invention is to achieve easy sharing of diagnostic record information inputted on paper medical charts between a plurality of medical facilities.

### Means to Solve the Problem

For solving the aforesaid problem, the diagnostic record information management system of the invention is an information management system that controls diagnostic record information of plural medical facilities connected to be capable of transmitting and receiving data through a communication network. This system is characterized to be equipped with a reading device that reads paper medical charts on which diagnostic record information is recorded at the plural medical facilities, and makes the diagnostic record information to be image data, a storing device that stores the diagnostic record information converted into the image data to make a data base for each medical facility, a notifying device that notifies at least one of the plural medical facilities of a medical term to be searched for in one of plural medical facilities from diagnostic record information stored in the storing device, a hand-writing input device that is provided on each medical facility where paper medial charts are used among aforesaid plural medical facilities, and inputs a pattern of hand-written characters corresponding to the medical term to be searched for, a searching device that conducts pattern-matching between the diagnostic record information stored in the data base corresponding to a medical facility having the hand-writing input device and the inputted pattern of hand-written characters when the pattern of hand-written characters is inputted from the hand-writing input device, and searches for diagnostic record information including the aforesaid inputted pattern of hand-written characters, and with a transmitting device that transmits the aforesaid searched diagnostic record information to the aforesaid one medical facility.

Further, for solving the aforesaid problem, the diagnostic record information management method of the invention is one that controls diagnostic record information of plural medical facilities connected to be capable of transmitting and receiving data through a communication network. This method is characterized to include a process to convert diagnostic record information into image data in the plural medical facilities by reading paper medical charts on which diagnostic record information is recorded with a reading device, a storing process to store diagnostic record information converted into image data in a storing device to make a data base for each medical facility, a process to notify at least one of the aforesaid plural medical facilities of medical term to be searched for in one medical facility among the aforesaid plural medical facilities from diagnostic record information stored in the aforesaid storing device, a process to input, by a hand-writing input device, a pattern of hand-written characters corresponding to the aforesaid medical term to be searched for, in each medical facility where paper medical charts are used among the plural medical facilities, a process to conduct pattern matching between diagnostic record information stored in the data base corresponding to the medical facility where the hand-writing input is conducted and the inputted pattern of hand-written characters, when the pattern of hand-written characters is inputted from the aforesaid hand-writing input device, and to search for diagnostic record information including a pattern of the inputted hand-written characters and a process to transmit the searched diagnostic record information to the aforesaid one medical facility.

### EFFECTS OF THE INVENTION

In the present invention, even when an expression used for recording the same medical term in a paper medical chart is different from each other in each medical facility, it is possible to search easily for diagnostic record information including a character corresponding to medical term to be searched for, from image data of diagnostic record information obtained by reading paper medical chart with a reading device, and it is possible to share easily diagnostic record information recorded on paper medical chart in plural medical facilities.

### BRIEF DESCRIPTION OF THE DRAWINGS

FIG. 1 is a diagram showing an overall structure of medical chart management system 100 relating to the invention.

FIG. 2 is a block diagram showing a functional structure of management server 1 in FIG. 1.

FIG. 3 is a block diagram showing a functional structure of terminal device 2 in FIG. 1.

FIG. 4 is a flow diagram showing medical chart information searching sequence carried out in medical chart management system 100 in FIG. 1.

FIG. 5 is a flow diagram showing medical chart information searching sequence carried out in medical chart management system 100 in FIG. 1.

### DESCRIPTION OF SYMBOLS

100. Medical chart management system
1. Management server
2. Terminal device
11, 21. CPU
12, 22. Input section
13, 23. Display section
14, 24. Communication section
15, 25. RAM
16, 26. Storing section
17. Paper medical chart information DB
171. Paper medical chart DB
172. Related information DB
18. Electronic medical chart information DB
27. Scanner
19, 28. Bus

### DESCRIPTION OF THE PREFERRED EMBODIMENT

First, a structure of the present embodiment will be described.

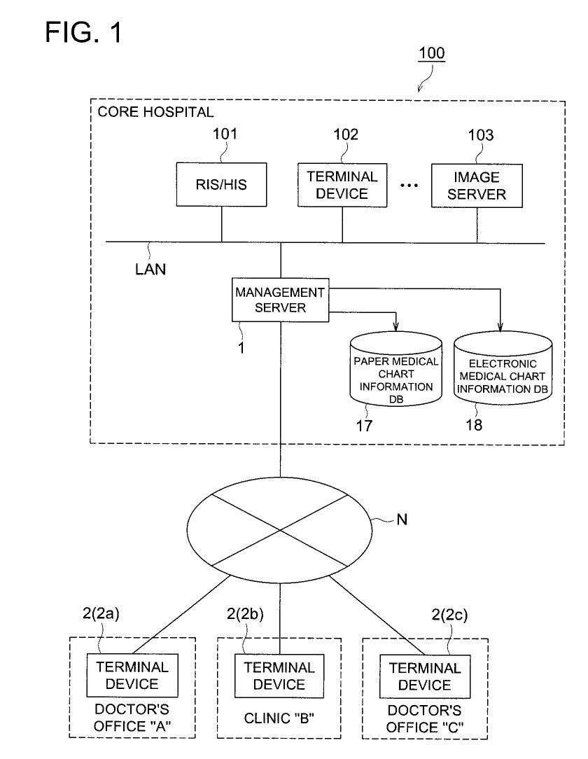

FIG. 1 is a conceptual diagram showing a system structure of medical chart management system 100 in the present embodiment. The medical chart management system 100 is a diagnostic record information management system in which the diagnostic record information recorded on paper medical chart is shared in plural medical facilities (for example, core hospitals in the region, medical practitioner's offices and clinics) in the same region, wherein management server 1 provided in the core hospital in the region and terminal device 2 provided in a small-sized medical facility such as each doctor's office or a clinic in the region (in this case, terminal device 2a provided in doctor's office A, terminal device 2b provided in clinic B and terminal device 2c provided in doctor's office C) are connected to be capable of transmitting and receiving data through communication network N, to be constructed. The communication network N is an information communication network constructed by using private lines, existing public networks and the internet.

In this case, the core hospital means a large-sized medical facility wherein a plurality of diagnostic departments are provided, and in-house networks are constructed. In contrast to this, a medical practitioner's office and a clinic mean a small-sized medical facility wherein only one medical doctor manages, and a facility and a medical doctor are in the relationship of 1:1. In the present embodiment, it is assumed that diagnostic record information of a patient is prepared by electronic medical charts to be preserved and managed in the core hospital, while, diagnostic record information of a patient is prepared by recording on paper medical charts to be preserved and managed in the small-sized medical facility such as a doctor's office and a clinic.

Management server 1 provided in a core hospital is a server having paper medical chart information DB17 and electronic medical chart information DB18 wherein electronic medical chart data made in the core hospital and image data of paper medical charts made in other medical facilities connected through communication network N are managed. Further, management server 1 is connected with in-house LAN (Local Area Network) serving as an in-house network constructed in the core hospital, and it is connected with in-house information system 101 such as RIS/HIS, terminal device 102 provided in each diagnosis room in the hospital and image server 103 that is equipped with image DB (Data Base) storing radiographed image data of a patient radiographed in the hospital, to be capable of transmitting and receiving data.

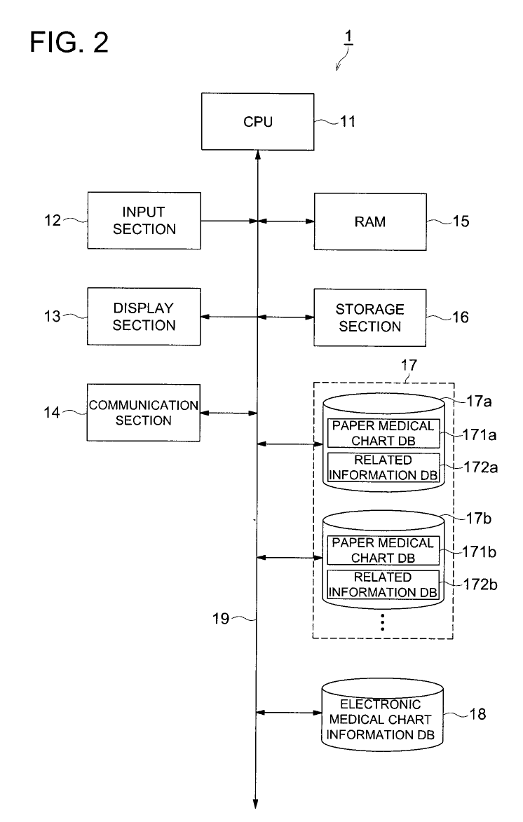

FIG. 2 shows an example of a functional structure of management server 1. As shown in FIG. 2, the management server 1 is equipped with CPU 11, input section 12, display section 13, communication section 14, RAM 15, storing section 16, paper medical chart information DB 17 and electronic medical chart information DB 18, and each section is connected through bus 19.

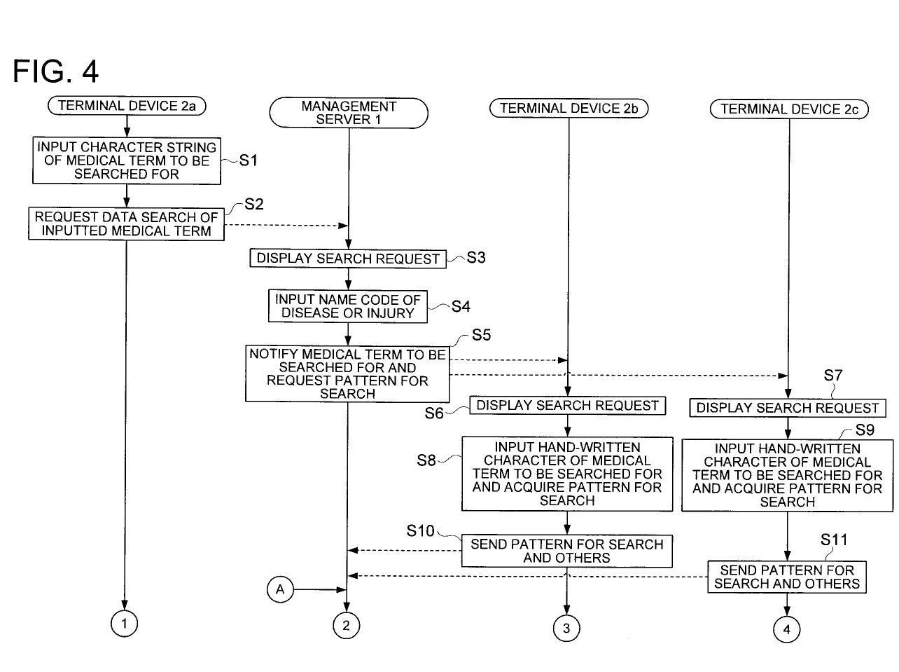

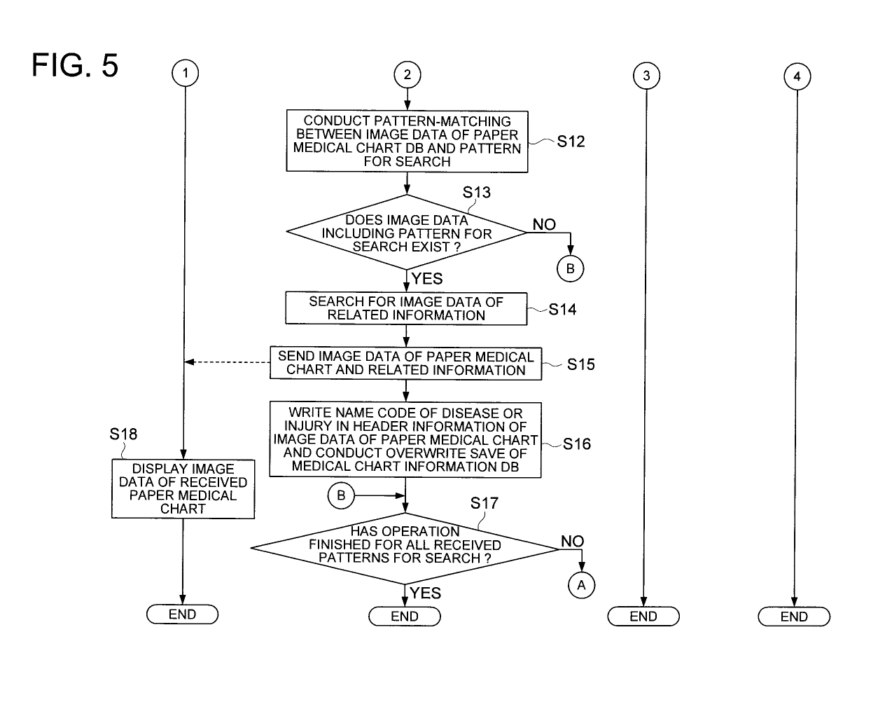

CPU (Central Processing Unit) 11 reads out a system program stored in storing section 16, then, develops it on a work area formed in RAM 15, and controls each section in accordance with the system program. Further, the CPU 11 reads out various types of processing programs including a processing program on the management server 1 side in a medical chart information searching sequence in FIGS. 4 and 5 stored in storing section 16, then, develops it on a work area, and various types of processing including processing on the management server 1 side in the medical chart information searching sequence in FIGS. 4 and 5 are conducted through cooperation with a program thus read out. The CPU 11 realizes a communication device, a searching device and a transmitting device by conducting processing on the management server 1 side in the medical chart information searching sequence in FIGS. 4 and 5.

Input section 12 is composed of a keyboard that is equipped with cursor keys, numerical input keys and various types of functional keys and of a pointing device such as a mouse, and it outputs pressing signals of the key pressed on the keyboard and operating signals by the mouse to CPU 11 as input signals.

Display section 13 is composed of monitors such as LCD (Liquid Crystal Display) and CRT (Cathode Ray Tube), and it displays input instructions from input section 12 and data, in accordance with an instruction of display signals inputted from CPU 11.

Communication section 14 is composed of communication devices such as a LAN adaptor, a modem, a TA (Terminal Adaptor) and a router, and it conducts transmitting and receiving of data with terminal device 2 of each medical facility connected to communication network N and with each device connected to in-house LAN.

In various types of processing controlled by CPU 11, RAM (Random Access Memory) 15 forms a work area storing temporarily various programs feasible by CPU 11 which are read out from storing section 16, input data, output data or parameters.

Storing section 16 is composed of HDD (Hard Disc Drive) and nonvolatile semiconductor memory, and it stores system programs conducted by CPU 11 and various types of processing programs including a processing program on the management server 1 side in medical chart information searching sequence in FIGS. 4 and 5. These various types of programs are stored in a form of a readable program code, and CPU 11 operates in succession in accordance with the program code.

Paper medical chart information DB 17 is a storing device that stores image data of paper medical charts transmitted from each medical facility connected through communication network N and image data of a series of materials (hereinafter referred to as related information) such as radiographed images consulted during recording of paper medical charts, after making them to be a database. The paper medical chart information DB 17 is provided in each medical facility, and it is composed of paper medical chart DB 171 that stores image data of each paper medical chart and the related information DB 172 that stores image data of the related information. In the present embodiment, the paper medical chart information DB 17 is equipped with paper medical chart information DB 17a having paper medical chart DB 171a and related information DB 172a of doctor's office A, paper medical chart information DB 17b having paper medical chart DB 171b and related information DB 172b of clinic B and with paper medical chart information DB 17c having paper medical chart DB 171c and related information DB 172c of doctor's office C.

Electronic medical chart information DB 18 is a database that stores data of electronic medical charts made in a core hospital.

Terminal device 2 (terminal device 2a, terminal device 2b or terminal device 2c) is a PC (personal computer) installed in each medical facility that is connected to communication network N.

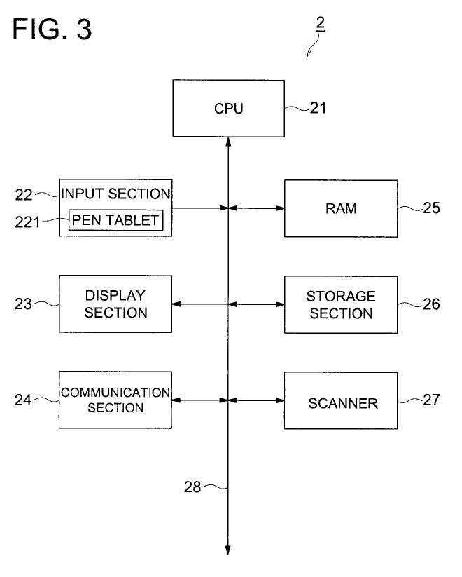

FIG. 3 shows an example of a functional structure of terminal device 2. As shown in FIG. 3, the terminal device 2 is composed of CPU 21, input section 22, display section 23, communication section 24, RAM 25, storing section 26 and of scanner 27, and each section is connected through bus 28.

The CPU 21 reads out a system program stored in storing section 26, then, develops it on a work area formed in RAM 25 and controls each section in accordance with the aforesaid system program. Further, the CPU 21 reads out various types of processing programs including the processing program on the terminal device 2 side in the medical chart information searching sequence in FIGS. 4 and 5 which are stored in storing section 26, and develops them on a work area. The CPU 21 carries out various types of processing including the processing on the terminal device 2 side in the medical chart information searching sequence in FIGS. 4 and 5, through cooperation with programs thus read out.

Input section 22 is composed of a keyboard that is equipped with cursor keys, numerical input keys and various types of functional keys and of a pointing device such as a mouse, and it outputs pressing signals of the key pressed on the keyboard and operating signals by the mouse to CPU 21 as input signals. Further, the input section 22 is equipped with pen tablet 221 that serves as a hand-writing input device, and detects a locus such as hand-written characters and graphics written on the tablet body composed of a liquid crystal panel and a sensor base plate by a special input pen, to output the detected signals to CPU 21.

Display section 23 is composed of a monitor such as LCD and CRT, and displays input instruction coming from the input section 22 and data, complying with an instruction of display signals inputted from CPU 21.

Communication section 24 is composed of communication devices such as a modem, a TA and a router, and it conducts transmitting and receiving of data with outer equipment such as terminal device 2 in another medical facility and management server 1 in a core hospital connected to communication network N.

In various types of processing controlled by CPU 21, RAM 25 forms a work area storing temporarily various types of programs which are read out from storing section 26 and are feasible by CPU 21, input data, output data or a parameter.

Storing section 26 is composed of HDD and nonvolatile semiconductor memory or the like, and it stores various types of processing programs including a system program executed by CPU 21, processing program on the terminal device 2 side in the medical chart information searching sequence in FIGS. 4 and 5, and paper medical chart reading program and various types of data. These various types of programs are stored in a form of program codes capable of being read, and CPU 21 conducts successively operations following the aforesaid program codes.

Scanner 27 representing a reading device is composed of a light source, a CCD (Charge Coupled Device) and an A/D converter or the like, and it reads images of a document by forming images from reflected light of a beam emitted from a light source to the document and used for illuminating and scanning and by conducting photoelectric transduction, and converts the image thus read into digital image data through an A/D converter, to output to CPU 21.

Next, operations in the present embodiment will be described.

In a core hospital, a doctor starts an electronic medical chart creating program by operations of an input section of a keyboard and a mouse, in terminal device 102 provided in each doctor's room, inputs information of a doctor such as doctor ID and a name of the doctor, information of a patient such as patient ID and a name of the patient to be examined and a code of disease or injury name corresponding to the disease or injury of the patient, then, thereby makes an electronic medical chart from an electronic medical chart creating screen, and inputs image ID of radiographed images consulted in the course of making medical charts. Then, the information of doctor, the information of a patient, the data of electronic medical charts and the image ID are transmitted to management server 1 after being correlated to each other. In the management server 1, electronic medical chart data transmitted from each terminal device 102 are caused to correspond to each of information of a doctor, information of a patient, information of an image and a code of disease or injury name, and are stored in electronic medical chart information DB 18. In this case, the code of disease or injury name is a code given uniquely to each disease or injury name, for the purpose of sharing electronic medical chart data and image data of paper medical chart in each medical facility connected to medical chart management system 100 in a core hospital, and for example, a code of ICD10 (International Statistical Classification of Disease and Related Health Problems Tenth Revision) representing a standard of a disease and injury name code is used.

In each medical facility where paper medical charts are used, a doctor examines a patient in a diagnosis room and enters results of the diagnosis (diagnostic record information) in a paper medical chart. Then, when a paper medical chart reading program is started by the doctor through operations of inputting section 22 of terminal device 2, and scanner 27 is caused to read a paper medical chart wherein diagnostic record information has been entered and related information such as radiographed images consulted in the course of entering in the paper medical chart, after inputting patient information of the patient to be examined following the display on the display screen. Then, the paper medical charts and the related information are read in the scanner 27, and image data of the paper medical charts, namely, image data of the diagnostic record information entered in the paper medical chart and image data of the related information are acquired to be outputted to CPU 21. In the CPU 21, a reading ID is given to each of image data of paper medical chart and image data of related information which are read by scanner 27, and patient information and a reading ID of a series of related information read simultaneously are written in a header of image data of the paper medical chart, thus, image data of the paper medical chart and of the related information are transmitted to management server 1 by communication section 24 through communication network N. In the management server 1, when image data from each medical facility are received through communication section 14, image data of the paper medical chart are stored in paper medical chart DB 171 that corresponds to the medical facility representing the transmitter, and image data of the related information are stored in related information DB 172 that corresponds to the medical facility representing the transmitter. Further, even for the paper medical chart made in the past, image data thereof are read by scanner 27 in the same way, and the image data are stored in paper medical chart DB 171.

Namely, in management server 1 of a core hospital, there are stored image data of paper medical chart of each medical facility that is connected to communication network N and that employs paper medical chart in the same region, in addition to electronic medical chart data of the core hospital. In each medical facility, when diagnostic record information for the similar case for a patient visiting the facility needs to be consulted, it is possible to search for image data including a medical term corresponding to a medical term to be searched for from image data of paper medical chart of another medical facility, and to make the searched image data to be displayed on display section 23 of terminal device 2 in its medical facility, by accessing the management server 1 of the core hospital from the terminal device 2 and by requiring searching of a medical term to be searched for, through the medical chart information searching sequence shown in FIGS. 4 and 5.

The medical chart information searching sequence conducted in medical chart management system 100 will be described as follows, referring to FIGS. 4 and 5. Incidentally, FIGS. 4 and 5 show an example wherein a doctor of doctor's office A wants to search for “micro-calcification cluster” that is a name of disease or injury (a medical term).

First, when an instruction of display of a paper medical chart searching screen is inputted from terminal device 2a installed in doctor's office A through operations of input section 22, the paper medical chart searching screen (not shown) is displayed on display section 23. when a medical term to be searched for from the paper medical chart searching screen, for example, a character string of “micro-calcification cluster”, is inputted by input section 22 (step S1), data and a searching request for the inputted medical term are transmitted to management server 1 through communication section 24 (step S2).

In the management server 1, when a searching request and data of medical term to be searched for are received through communication section 14, a message saying that “A request for search has arrived. Please input a code of disease or injury name corresponding to “micro-calcification cluster” is displayed on display section 13 (step S3), and if the code of disease or injury name corresponding to “micro-calcification cluster” representing a medical term to be searched for is inputted (step S4), a transmission request of a pattern for search corresponding to the medical term, the inputted code of disease or injury name and a terminal ID (terminal ID of terminal device 2a, in this case) of the transmitter are transmitted to terminal device 2 (terminal device 2b and terminal device 2c in this case) of each medical facility employing paper medical chart, through communication section 14, whereby, the medical term to be searched for is notified (step S5; notifying device).

In this case, when expressing medical terms in medical facilities, the Japanese language, the German language and the English language coexist, or, an expression used only in each medical facility exists, or different expressions are used in many cases for indicating the same content in different medical facilities. Further, the data stored in paper medical chart information DB 17 are image data of diagnostic record information hand-written by a doctor in each medical facility. Therefore, it is not possible to take out information including desired medical term, even when searching paper medical chart information DB 17 for data of a medical term to be searched for without taking any action on the data. Therefore, management server 1 requests, from each medical facility, a pattern for search corresponding to a medical term required to be searched for, for making it possible to search for the diagnostic record information including the expression corresponding to the medical term required to be searched for from paper chart information DB 17. The pattern for search represents image data of a hand-written character pattern in the case of inputting, by hand-writing, the expression which is used corresponding to the medical term to be searched for in each medical facility.

In terminal device 2 (terminal devices 2b and 2c) of each small-sized medical facility, when a transmission request for a pattern for search is received through communication section 24, a message showing request for search saying that “A request for search has arrived. Please input a medical term described on medical charts corresponding to “micro-calcification cluster” with a pen tablet” is displayed on display section 23 (steps S6 and S7). A doctor of each doctor's office inputs an expression corresponding to “micro-calcification cluster” used in that medical facility, namely, an expression used in the case when the doctor enters “micro-calcification cluster” on paper medical chart. For example, the doctor inputs “micro-calcification”. In the case when the “micro-calcification” is used for entering on paper medical chart, with hand-written characters by pen tablet 221. When “calcified cluster” is used for entering in paper medical chart, the “calcified cluster” is inputted with hand-written characters by pen tablet 221. When a medical term is inputted with hand-written characters from pen tablet 221, and when image data of hand-written character pattern of the expression with which the medical term to be searched for is entered in a paper medical chart in the medical facility are acquired (steps S8 and S9), the acquired hand-written character pattern, namely, the pattern for search is transmitted to management server 1 through communication section 24 together with terminal ID of the transmitter and a disease or injury name code (steps S10 and S11).

In the management server 1, when the pattern for search, the disease or injury name code and the terminal ID of the transmitter of the searching request are received, pattern matching is conducted between image data stored in paper medical chart DB 171 (paper medical chart DB 171b or paper medical chart DB 171c, in this case) corresponding to a medical facility of the transmitter of the pattern for search and the received pattern for search, and the image data of a paper medical chart including the pattern for search are searched for (step S12; searching device). When image data including a pattern for search are existent (step S13; YES), image data of related information to which reading ID included in a header of the searched image data is attached are further searched for from related information DE 172 (step S14), and image data of the searched paper medical chart and image data of related information are transmitted to terminal device 2a of the transmitter of the searching request, through communication section 14 (step S15; transmitting device). Further, the received code of disease or injury name is written in header information of image data of the searched paper medical chart together with the pattern for search, and the image data of paper medical chart DB 171 are overwritten for preservation (step S16). Processes of steps S12-S16 are conducted for all patterns for search received from terminal device 2 of each medical facility.

In the terminal device 2a, when image data of paper medical chart and image data of related information are received from management server 1 through communication section 14, images based on the received image data of the paper medical chart are displayed on display section 23 (step S18).

Incidentally, in the case of searching for an electronic medical chart of a core hospital from each small-sized medical facility, when a searching request is made for management server 1 by inputting a code of disease or injury name through keys from terminal device 2 of each small-sized medical facility, it is possible to use the code of a disease or injury name transmitted in management server 1 as a key for searching and to transmit data of the searched electronic medial chart to terminal device 2 that requested searching, because a code of a disease or injury name is caused to correspond to data of each electronic medical chart.

In medical chart management system 100, paper medical charts made in each small-sized medical facility where paper medical charts are employed are read by scanner 27 installed in each small-sized medical facility to become image data which are stored in medical chart information DB 17 of management server 1 corresponding to each medical facility, as described above. When searching for a paper medical chart including contents about a certain disease or injury in other medical facilities is requested by a doctor of each medical facility, if searching is required for management server 1 by inputting, from input section 22, a medical term of a disease or injury name to be searched, a pattern for search corresponding to the medical term is required for terminal devices 2 of other medical facilities, in management server 1. In each medical facility where request for pattern for search is received, the pattern for search is acquired by inputting the expression used in the case of entering the medical term for disease or injury in a medical chart from pen tablet 221 of terminal device 2 with a hand written character, and that pattern for search is transmitted to management server 1. In the management server 1, pattern matching is conducted between image data of paper medical chart stored in paper medical chart DB 171 corresponding to the medical facility representing the transmitter of the pattern for search and the received pattern for search. When the image data including the character agreeing with the pattern for search has been searched out through the pattern matching, image data of the searched paper medical chart and image data of related information are transmitted to terminal device 2 that required searching.

Therefore, by reading paper medical charts with scanner 27, without inputting diagnostic record information entered in the paper medical charts, it is possible to computerize the information simply. Further, even in the case of entering a medical term of the same disease or injury name in paper medical charts, there is an occasion where an expression used in each medical facility is different from one in others. However, in the present system, searching is carried out by conducting pattern matching between the pattern for search made by inputting the expression used when each doctor enters the medical term to be searched for in paper medical chart in each medical facility with hand-written characters by the pen tablet, and image data of paper medical charts of DB corresponding to each medical facility. Therefore, it is possible to share easily the diagnostic record information entered in paper medical charts, even in the medical facilities where the expressions of the medical term on paper medical charts are different from each other.

Further, on the image data of paper medical charts searched for once from another medical facility, a code of a disease or injury name corresponding to the disease or injury name in the paper medical charts is written in header information to accompany therewith. Thus, it is possible to search with a code of a disease or injury name as a key, when searching from the medical facility next time, or from another medical facility.

Since terminal devices 2 (2a, 2b and 2c) are provided in a plurality of medical facilities in the same region, and management server 1 is provided in a core hospital in this region, diagnostic record information entered in paper medical charts can be shared easily in the same region.

Further, scanner 27 is installed in each medical facility employing paper medical charts, and paper medical charts newly made are read by the scanner 27 of each medical facility to be transmitted to management server 1 as image data, and are preserved in a paper medical chart DB 171 corresponding to each medical facility. Therefore, it is possible to share easily diagnostic record information of paper medical chart made newly in each medical facility.

Incidentally, contents of the description in the aforesaid embodiment represent a preferred example of medical chart management system 100 relating to the invention, and the invention is not limited to this.

For example, although management server 1 is installed in a core hospital in the aforesaid embodiment, it is also possible to provide a data center that is controlled by a core hospital, and to install management server 1 in the data center.

Further, when a medical term needs to be searched for by a certain medical facility from diagnostic record information of paper medical chart alone in the medical facility, it is possible to search for image data of paper medical chart from only DB of that facility, by inputting a pattern for search with pen tablet 221 and by making a searching request by transmitting inputted pattern for search to management server 1 through communication section 24.

Further, though medical chart information DB 17 of each medical facility is controlled by management server 1 in the aforesaid embodiment, it is also possible to provide it in each medical facility. In this case, in each medical facility that has received request of pattern for search from management server 1, an expression used in the case of entering the medical term on the medical chart is inputted through hand-writing to acquire a pattern for search from pen tablet 221 of terminal device 2, and image data including an expression corresponding to the medical term are searched for by conducting pattern matching between the pattern for search and image data of paper medical chart stored in paper medical chart DB 171. When the image data including the pattern for search are searched out, image data of related information are searched for from related information DB 172, image data of the searched paper medical chart and image data of related information are transmitted to management server 1 through communication section 24. Or, they can be also transmitted directly to terminal device 2 of the transmitter. In this way, it is possible to input a medical term to be searched for from a pen tablet through no network N, and thereby, to search DB with the inputted pattern for search, when searching for image data of paper medical chart of own facility. Namely, it is possible to acquire image data of paper medical chart in own facility through no communication network N, and to display them. Further, a doctor can display image data searched out according to the search request from management server 1 on display section 23 to confirm them, and paper medical chart of an original sheet of the searched image data and an original text of the related information can also be sent to the medical facility that required searching.

There has been described an occasion wherein the relationship of a small-sized medical facility employing paper medical chart and the doctor are on a one-to-one basis, in the aforesaid embodiment. However, when a plurality of doctors are existent in a small-sized medical facility, it can be arranged so that paper medical chart DB 171 and related information DB 172 of each doctor are provided in medical chart information DB 17, and when acquiring a pattern for search by conducting input with a hand-writing pen complying with searching request in terminal device 2, it can be arranged so that doctor information such as doctor ID may be inputted, and when searching based on the pattern for search in management server 1, it can be arranged so that searching may be conducted in the DB corresponding to a doctor who inputted a pattern for search with hand-written characters.

In addition, even with respect to detailed structures and detailed operations of each device constituting medical chart management system 100, they can be varied properly without departing from the spirit and scope of the invention.

What is claimed is:

1. A diagnostic record information management system which controls diagnostic record information of a plurality of medical facilities connected to be capable of transmitting and receiving data through a communication network, the diagnostic record information management system comprising:
a reading device which reads a paper medical chart on which the diagnostic record information is recorded at the plurality of medical facilities, and which converts the diagnostic record information into image data;
a storing device which stores the diagnostic record information converted into the image data to make a data base for each of the medical facilities;
a notifying device which notifies at least one of the plurality of medical facilities of a medical term to be searched for in one medical facility among the plurality of medical facilities from the diagnostic record information stored in the storing device;
a handwriting input device which is provided on each medical facility where a paper medial chart is used, among the plurality of medical facilities and which inputs a pattern of hand-written characters corresponding to the medical term to be searched for;
a searching device which searches for diagnostic record information including the inputted pattern of hand-written characters by conducting pattern-matching, when the pattern of hand-written characters is inputted from the hand-writing input device, between the diagnostic record information stored in the data base corresponding to a medical facility having the hand-writing input device from which the pattern is inputted and the inputted pattern of hand-written characters; and
a transmitting device which transmits the diagnostic record information searched out to the one medical facility.

2. The diagnostic record information management system of claim 1,
wherein the plurality of medical facilities are located in a same region and the storing device, the searching device and the transmitting device are provided in a core hospital of the region.

3. The diagnostic record information management system of claim 2,
wherein the reading device is provided in each medical facility where a paper medical chart is used, among the plurality of medical facilities and the reading device provided in the each medical facility outputs image data of a newly read paper medical chart to the storing device through the communication network.

4. A diagnostic record information management method which controls diagnostic record information of a plurality of medical facilities connected to be capable of transmitting and receiving data through a communication network, the diagnostic record information management method comprising the steps of:
converting the diagnostic record information into image data by reading a paper medical chart on which the diagnostic record information is recorded, with a reading device at the plurality of medical facilities;
storing the diagnostic record information converted into the image data in a storing device to make a data base for each of the medical facilities;
notifying at least one of the plurality of medical facilities of a medical term to be searched for in one medical facility among the plurality of medical facilities from the diagnostic record information stored in the storing device;
inputting a pattern of hand-written characters corresponding to the medical term to be searched for, by a hand-writing input device, in each medical facility where a paper medical chart is used among the plurality of medical facilities;
searching for diagnostic record information including the inputted pattern of hand-written characters by conducting pattern matching, when the pattern of hand-written characters is inputted from the hand-writing input device, between the diagnostic record information stored in the data base corresponding to the medical facility where the input of the pattern of hand-written characters is conducted and the inputted pattern of hand-written characters; and
transmitting the diagnostic record information searched out to the one medical facility.

5. The diagnostic record information management method of claim 4,
wherein the plurality of medical facilities are located in a same region and the storing device is provided in a core hospital of the region.

6. The diagnostic record information management method of claim 5,
wherein the reading device is provided in each medical facility where a paper medical chart is used, among the plurality of medical facilities and the reading device provided in the each medical facility outputs image data of a newly read paper medical chart to the storing device through the communication network.
